(19) United States
(12) Patent Application Publication
(10) Pub. No.: US 2007/0100658 A1
(43) Pub. Date: May 3, 2007

(54) Formation and expansion method for a medical case study collection

(76) Inventors: Thomas Birkhoelzer, Radolfzell (DE); Frank Krickhahn, Herzogenaurach (DE); Juergen Vaupel, Weisendorf (DE)

Correspondence Address: HARNESS, DICKEY & PIERCE, P.L.C., P.O. Box 8910, Reston, VA, 20195, US

(21) Appl. No.: 10/348,020

(22) Filed: Jan. 22, 2003

(30) Foreign Application Priority Data
Jan. 22, 2002 (DE) 102 02 285.2

(51) Int. Cl. G06Q 10/00; G06Q 50/00

(52) U.S. Cl. 705/2

(57) ABSTRACT

A computer transmits at least one medical case study to a central computer. The central computer determines classification features relating to the case study and a cross-reference to the case study, at which the case study can be called up by a user computer. Alternatively, the computer transmits the classification features and the cross-reference to the central computer. Classification features and a cross-reference are recorded by the central computer in a case study collection, thus forming or expanding this case study collection.

The present application hereby claims priority under 35 U.S.C. §119 on German patent application number DE 10202285.2 filed Jan. 22, 2002, the entire contents of which are hereby incorporated herein by reference.

### FIELD OF THE INVENTION

The present invention generally relates to a formation and expansion method for a medical case study collection having a number of medical case studies.

### BACKGROUND OF THE INVENTION

Case study collections are used in many fields of application, for example including the field of medicine. Case study collections such as these are generally maintained as local case study collections on the respective user computers. The case study collection is updated from a central point, for example by dispatching an updated version by post or via the Internet.

US 2002/0016539 A1 relates to an evaluation system for obtaining diagnostic information from signals and data from medical sensor systems. A method for classification of skin or mucous membrane changes which can be observed visually is known from DE 100 21 431 A1.

### SUMMARY OF THE INVENTION

An object of an embodiment of the present invention is to make it possible to create a large case study collection and to provide this in a networked manner in a way which is as simple as possible.

The object may be achieved, for example, in that either at least one case study is transmitted to a central computer from a third computer and classification features relating to the case study and a cross-reference to the case study, at which the case study can be called up by a user computer, are determined by the central computer, or the classification features and the cross-reference are transmitted from the third computer to the central computer, and in that the classification features and the cross-reference are recorded by the central computer in a case study collection.

A case study collection concerns medical data relating to debilitations (illnesses and traumatic events). Data protection is critical for data such as this. Furthermore, case study collections such as these are used in particular for the training of doctors and for providing verification of medical diagnoses. Thus, not only data protection but, furthermore, also factual correctness of the case studies are of critical importance. Only authorized persons should therefore be able to transmit case studies and/or classification features and cross-references to the central computer. This is preferably ensured by the third computer transmitting an identification code to the central computer before or together with the transmission of the case study and/or the classification features and the cross reference. This is further ensured by the central computer not recording the classification features and the cross reference in the case study collection unless the transmitted identification code corresponds to an authorization code which is contained in an access authorization list.

If an account which is associated with the authorization code is credited with a credit on the basis of the expansion of the case study collection, users of the third computer have an incentive to make case studies available to the central computer.

The case study collection is accessed in a way which is generally known for data banks. Thus, first of all, the user computer transmits to the central computer a selection criterion for case studies. The central computer uses the case study collection to determine case studies which satisfy the selection criterion and cross-references for these case studies, at which the case studies can be called up. In the case of a cross-reference to a case study which is stored in the third computer, the central computer either calls up this case study from the third computer and transmits it to the user computer, or transmits to the user computer the cross reference to the case study, or transmits to the third computer a transmission command to transmit the case study to the user computer.

If the user computer transmits an identification code to the central computer before or together with the transmission of the selection criterion and the case studies which satisfy the selection criterion are not determined unless the transmitted identification code corresponds to an authorization code which is contained in an access authorization list, only authorized users can access the case studies in the case study collection, as well. Data protection is thus maintained.

If an account which is associated with the authorization code is debited with a debit on the basis of the transmission of the selection criterion, this makes it possible in a simple manner for the operator of the case study collection to amortize his costs for making the case study collection available.

The user computer and the third computer may in principle be computers that are different to one another. However, they may also be identical to one another.

If the case studies are made anonymous, this ensures even better data protection.

### BRIEF DESCRIPTION OF THE DRAWINGS

Further advantages and details will be found in the following description of an exemplary embodiment in conjunction with the drawings, in which, illustrated in outline form:

FIG. 1 shows a computer network with a number of computers,

FIG. 2 shows a basic flowchart for a central computer,

FIG. 3 shows a basic flowchart for a user computer,

FIGS. 4 to 9 show variants of FIGS. 2 and 3, and

FIG. 10 shows an illustration of a case study.

### DETAILED DESCRIPTION OF THE PREFERRED EMBODIMENTS

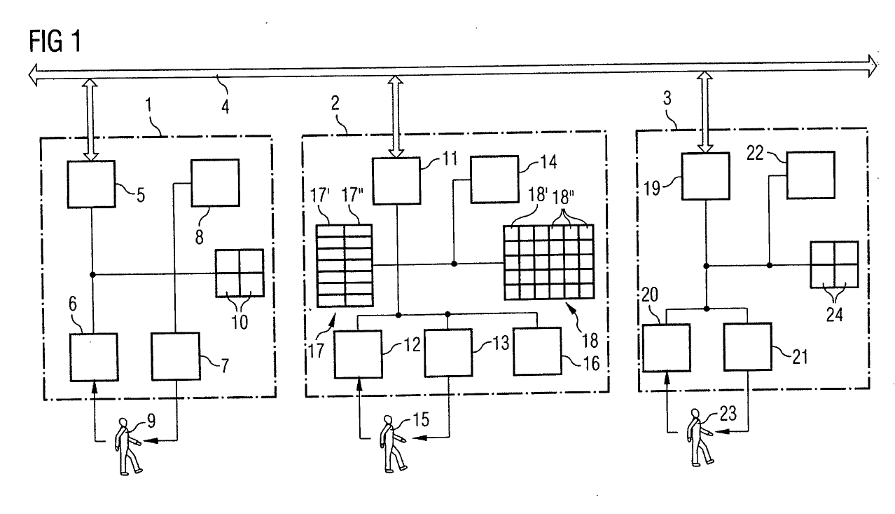

Three computers 1 to 3 are networked with one another via a computer network 4 in FIG. 1. The computer network 4 may in this case be a local area network or a global network, for example the Internet.

The computer 1 is a user computer and has a main unit 5, at least one input device 6 and at least one output device 7. It processes a computer program product 8, which is stored in a part of its memory. During the processing of the computer program product 8 (or of the user program 8), the main unit 5 transmits outputs via the output device 7 to a user 9, and receives inputs from this user 9 via the input device 6. In addition, medical case studies 10 are stored in a further part of the memory of the user computer 1.

The computer 2 is a central computer which also has a main unit 11, an input device 12 and an output device 13. It also processes a computer program product 14, which is stored in a part of its memory. It communicates with an operator 15 of the central computer 2 via the input device 12 and the output device 13.

During the processing of the computer program product 14 (or of the central computer program 14), the main unit 11 also accesses, inter alia, a buffer store 16, an access authorization list 17 and a case study collection 18. By way of example, case studies may be stored temporarily in the buffer store 16. The access authorization list 17 contains two columns 17′, 17″. Authorization codes are stored in the first column 17′. Accounts which are associated with the authorization codes are maintained in the right-hand column 17″. The accounts make it possible to invoice those who use the case study collection 18.

The case study collection 18 contains a number of columns 18′, 18″. The first column 18′ contains cross-references to case studies 10, 24. The further columns 18″ contain classification features which are satisfied by the case studies 10, 24 to which the associated cross-references refer.

The computer 3 is a third computer and likewise has a main unit 19, an input device 20 and an output device 21. It processes a computer program product 22, during the processing of which it communicates with an operator 23 of the third computer 3 via the input device 20 and the output device 21. The main unit 19 can also access the case studies 24 which are stored in the third computer 3.

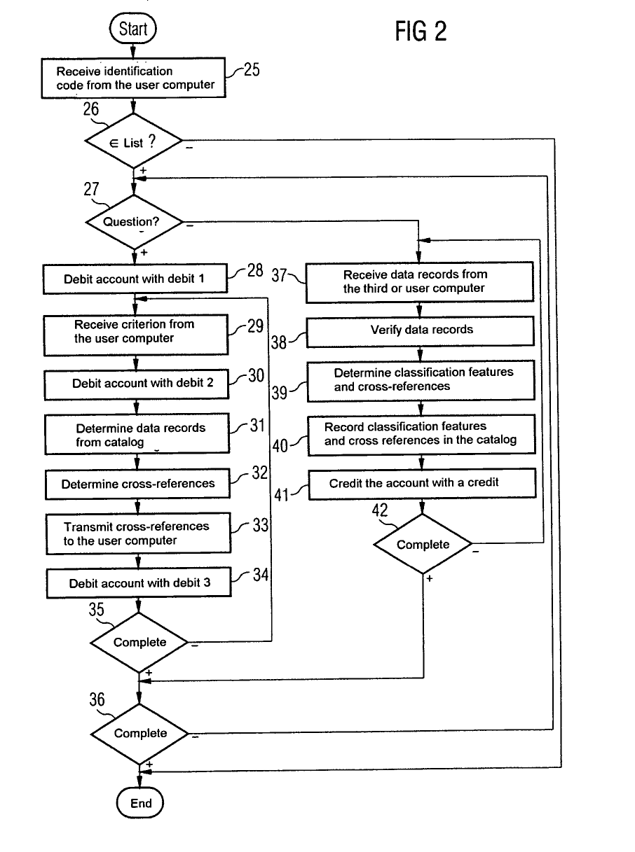

The computers 1 to 3 communicate with one another via the computer network 4. In this case, the central computer 2 processes the central computer program 14 as described in the following text in conjunction with FIG. 2.

As shown in FIG. 2, in a step 25, the central computer 2 first of all receives an identification code from the user computer 1. The identification code is thus transmitted to it. In a step 26, the central computer 2 then checks whether the transmitted identification code corresponds to one of the authorization codes which are contained in the access authorization list 17. The subsequent steps are not carried out unless this is the case. Otherwise, the processing of the central computer program 14 is ended.

During the further processing, a check is first of all carried out in a step 27 to determine whether the user 9 does or does not wish to interrogate the case study collection 18. A jump is made either to a step 28 or to a step 37, depending on the result in the response.

First of all, in step 28, the account which is associated with the authorization code is debited with a first debit. This debit is independent of the complexity since it is made at the start of each new data bank session. The user computer 1 then transmits a selection criterion to the central computer 2 in a step 29. The account is then once again debited with a second debit in a subsequent step 30. The debiting of the second debit is dependent on the complexity, since the debit is made for each question (or for each transmission of a selection criterion).

In a subsequent step 31, the central computer 2 determines which of the case studies 10, 24 in the case study collection 18 satisfy the transmitted selection criterion. Cross references to the respective case studies 10, 24 can then be determined in a step 32 by reading the first column 18′ of the lines of the case study collection 18 determined in this way. The central computer 2 transmits the determined cross-references to the user computer 1, in a step 33. The appropriate account can once again be debited with a third debit in a step 34. This debit is also complexity-dependent, since it may be dependent on the number of determined case studies 10, 24 and/or on values associated with the case studies 10, 24.

A check is then carried out in a step 35 to determine whether the search has now ended. If yes, the process continues with a step 36, otherwise the process jumps back to step 29. If step 36 is carried out, a check is carried out to determine whether the processing of the central computer program 14 should now be ended. If yes, the processing is ended, otherwise a jump is made back to step 27.

If a jump is made from step 27 to step 37, the case study collection 18 is intended to be formed with case studies 10, 24, or expanded with new, additional case studies 10, 24. In this situation, by way of example, the central computer 2 receives case studies 10, 24 from the third computer 3 or from the user computer 1. In a step 38, the transmitted case studies 10, 24 are verified. The verification process may be carried out, for example, by transmitting the case studies 10, 24 to the operator 15 of the central computer 2 who then either confirms them as being in order or else rejects them as not being in order. If necessary, the case studies 10, 24 may also be transmitted back to the transmitting computer 1 or 3, with change requests added to them.

Classification features for the case studies 10, 24 and cross-references to the case studies 10, 24 are then determined in a step 39. The process of determining the classification features and the cross-references may be automated or may be carried out interactively. Once the classification features and the cross-references have been determined, these are recorded in the case study collection 18, in a step 40. The cross references are thus entered in the first column 18′, and the classification features are entered in the corresponding lines in the further columns 18″. The account which is associated with the identification code is then credited with a credit.

A check is then carried out in a final step 42 to determine whether the transmission of case studies 10, 24 has ended. If yes, the process jumps to step 36, otherwise it jumps back to step 37.

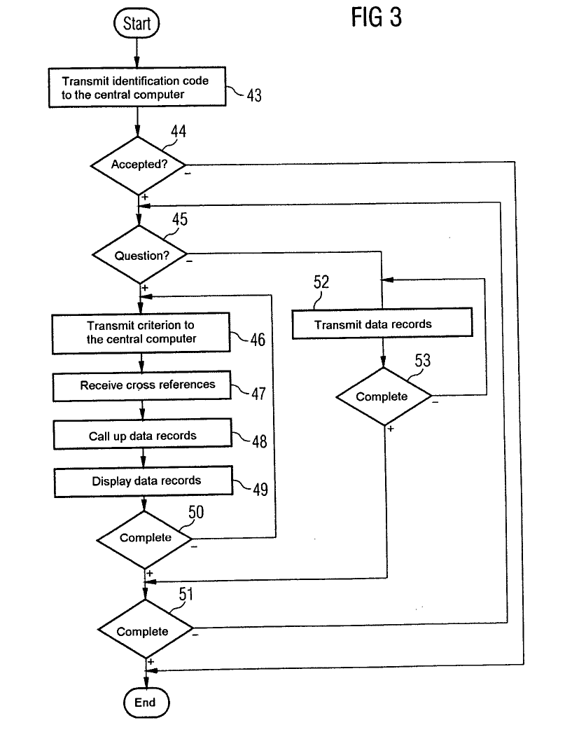

Depending on the configuration of the central computer program 14, the user computer 1 runs the user program 8, as will be explained in more detail in the following text in conjunction with FIG. 3.

As shown in FIG. 3, the user computer 1 first of all transmits the identification code to the central computer 2 in a step 43. A check is then carried out in a step 44 to determine whether the central computer 2 has accepted the transmitted identification code. Further steps 45 to 53 are not carried out unless this is the case, otherwise the processing of the user program 8 is ended.

During the further processing of the user program 8, a check is first of all carried out in a step 45 to determine whether an interrogation is intended to be passed to the case study collection 18. If yes, steps 46 to 50 are carried out, otherwise steps 52 and 53 are carried out.

In step 46, the user computer 1 transfers a selection criterion to the central computer 2. In step 47, the user computer 1 then receives cross-references to case studies 10, 24 from the central computer 2. In step 48, the user computer 1 calls up the case studies 10, 24. The case studies 10, 24 may in this case be stored on any of the computers, in particular in the user computer 1 itself, in the central computer 2 or in the third computer 3. The case studies 10, 24 which are called up are then displayed to the user 9 via the output device 7, for example, in step 49.

A check is carried out in step 50 to determine whether the search of the case study collection 18 has ended. If yes, a check is carried out in step 51 to determine whether the processing of the user program 8 should be ended completely. A jump back to step 45 is made only if this is not the case.

If the process jumps from step 45 to step 52, case studies 10 are intended to be recorded in the case study collection 18, with the case study collection 18 being formed or expanded in this way. In this case, the case studies 10 are transmitted to the central computer 2 in step 52. A check is then carried out in the next step 53 to determine whether the transmission of case studies 10 to the central computer 2 should be ended. Depending on the response, the process either jumps back to step 52 or jumps to step 51.

The user computer 1 can thus not only check case studies 10 in the central computer 2 but can also transmit case studies 24 to the central computer 2. It thus contains both functionalities.

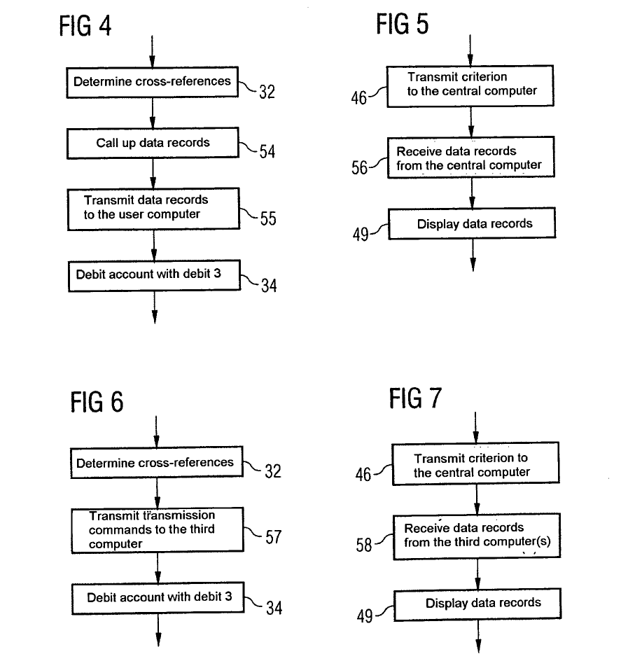

The program 22 of the third computer 3 will not be described in detail in the following text. It either has the same structure as the user program 8, or only that part which relates to the transmission of case studies 24 to the central computer 2. In conjunction with FIGS. 2 and 3, the situation has been described in which the central computer 2 transmits to the user computer 1 cross-references to the case studies 10, 24. However, alternative configurations are also possible, and these will be described in the following text in conjunction with FIGS. 4 and 5, as well as 6 and 7.

As shown in FIG. 4, the central computer 2 carries out steps 54 and 55 instead of step 33, in which the cross-references are transmitted to the user computer 1. In step 54, the central computer 2 itself calls up the case studies 10, 24 from the computers 1, 3 in which they are stored. In step 55, the central computer 2 then transmits the case studies 10, 24 to the user computer 1. According to FIG. 5, the user computer 1 carries out a step 56 instead of steps 47 and 48, in a corresponding manner to this. The user computer 1 receives the transmitted case studies 10, 24 from the central computer 2 in step 56.

According to FIG. 6, the central computer 2 transmits neither cross-references to case studies 10, 24 nor the case studies 10, 24 themselves to the user computer 1. In this case, transmission commands are transmitted in a step 57 to the respective computers 1, 3 in which the case studies 10, 24 are stored, for example to the third computer 3. These then themselves transmit the case studies 24 to the user computer 1. In a corresponding manner to this, the user computer 1 receives the case studies 24 from the third computer 3, or from third computers 3, in a step 58.

In conjunction with FIGS. 2 and 3, the above description has also covered how the case studies are themselves transmitted to the central computer 2. An alternative is also possible in this case, and this will be described in the following text in conjunction with FIGS. 8 and 9.

According to FIG. 8, the central computer 2 carries out a step 59 instead of steps 37 to 39. In step 59, the central computer 2 receives from the user computer 1 or from the third computer 3 the classification features and the cross-references to the case studies 10, 24 which are to be added to the case study collection 18. In a corresponding manner to this, the classification features and cross-references are determined by the user computer 1 (or possibly by the third computer 3) in a step 60, and are transmitted to the central computer 2 in a step 61. The steps 60 and 61 are carried out instead of the step 52. In this case, of course, it is necessary to ensure in some suitable manner that the case studies 10, 24 to be recorded in the case study collection 18 are in order.

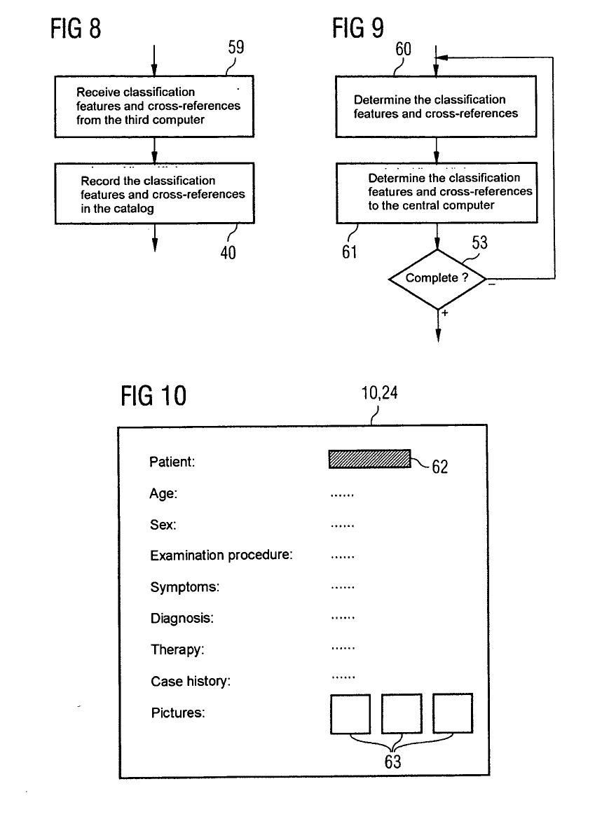

By way of example, FIG. 10 shows the layout of the medical case studies 10, 24. As shown in FIG. 10, the case studies 10, 24 have been made anonymous. The name of a patient is thus removed, blackened out or made illegible in some other way, for example by omitting the surname. This is indicated by a shaded block 62 in FIG. 10. As can also be seen in FIG. 10, the case study 10, 24 may contain details relating to the age or age group and sex of the patient. In any case, however, it contains details relating to the examination procedure used and to the debilitation symptoms found. Finally, the case study 10, 24 also contains a diagnosis and a preferred therapy. The case study 10, 24 may if required also contain a debilitation history (case history) as well as attached picture files 63. The case studies 10, 24 can be classified on the basis of various medical distinguishing criteria (for example body region, age, sex, diagnosis, etc.), and may be provided with appropriate descriptors.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A formation and expansion method for a medical case study collection including a plurality of medical case studies, comprising:
transmitting at least one case study to a central computer from another computer, wherein the case study is retrievable via a user computer; and
storing classification features relating to the case study and a cross-reference to the case study in the central computer in a case study collection.

2. The formation and expansion method as claimed in claim 1, wherein the other computer transmits an identification code to the central computer at least one of before and together with the transmission of the at least one case study, and wherein the central computer does not store the classification features and the cross-reference in the case study collection unless the transmitted identification code corresponds to an authorization code which is contained in an access authorization list.

3. The formation and expansion method as claimed in claim 2, wherein a credit is credited to an account associated with the authorization code, on the basis of the expansion of the case study collection.

4. The formation and expansion method as claimed in claim 1, wherein the user computer transmits to the central computer a selection criterion for case studies, wherein the central computer uses the case study collection to determine case studies which satisfy the selection criterion, wherein, for each case study which satisfies the selection criterion, the central computer determines a cross reference at which the case study can be called up, and wherein, in the case of a cross reference from the central computer to a case study stored in the other computer, at least one of,
the case study is called up from the other computer and is transmitted to the user computer,
the central computer transmits to the user computer the cross reference to the case study, and
the central computer transmits to the other computer a transmission command to transmit the case study to the user computer.

5. The formation and expansion method as claimed in claim 4, wherein an identification code is transmitted to the central computer from the user computer at least one of before and together with the transmission of the selection criterion, and wherein the case studies which satisfy the selection criterion are not determined unless the transmitted identification code corresponds to an authorization code which is contained in an access authorization list.

6. The formation and expansion method as claimed in claim 5, wherein an account which is associated with the authorization code is debited with a debit on the basis of the transmission of the selection criterion.

7. The formation and expansion method as claimed in claim 1, wherein the other computer is identical to the user computer.

8. The formation and expansion method as claimed in claim 1, wherein the case studies are made anonymous.

9. A computer program product for a central computer, for carrying out a formation and expansion method as claimed in claim 1.

10. A formation and expansion method for a medical case study collection including a plurality of medical case studies, comprising:
transmitting, from a computer to the central computer, at least one of
at least one case study, and
classification features of the case study and a cross reference to the case study, wherein the case study is retrievable by a user computer from the central computer.

11. The formation and expansion method as claimed in claim 10, wherein the computer transmits an identification code to the central computer at least one of before and together with the transmission of at least one of the case study and the classification features and the cross reference.

12. The formation and expansion method as claimed in claim 10, wherein the case studies are made anonymous.

13. The formation and expansion method as claimed in claim 10, wherein the computer is identical to the user computer, wherein the user computer transmits a selection criterion for case studies to the central computer, and wherein at least one of
the central computer transmits to the user computer at least one of case studies which satisfy the selection criterion and cross-references to case studies which satisfy the selection criterion, and
a further computer transmits to the user computer case studies which satisfy the selection criterion.

14. The formation and expansion method as claimed in claim 13, wherein the user computer transmits an identification code to the central computer at least one of before and together with the transmission of the selection criterion.

15. A computer program product for a computer for carrying out a formation and expansion method as claimed in claim 10.

16. The formation and expansion method as claimed in claim 2, wherein the user computer transmits to the central computer a selection criterion for case studies, wherein the central computer uses the case study collection to determine case studies which satisfy the selection criterion, wherein, for each case study which satisfies the selection criterion, the central computer determines a cross reference at which the case study can be called up, and wherein, in the case of a cross reference from the central computer to a case study stored in the third computer, at least one of,
the case study is called up from the third computer and is transmitted to the user computer,
the central computer transmits to the user computer the cross reference to the case study, and
the central computer transmits to the third computer a transmission command to transmit the case study to the user computer.

17. The formation and expansion method as claimed in claim 3, wherein the user computer transmits to the central computer a selection criterion for case studies, wherein the central computer uses the case study collection to determine case studies which satisfy the selection criterion, wherein, for each case study which satisfies the selection criterion, the central computer determines a cross reference at which the case study can be called up, and wherein, in the case of a cross reference from the central computer to a case study stored in the third computer, at least one of,
the case study is called up from the third computer and is transmitted to the user computer,
the central computer transmits to the user computer the cross reference to the case study, and
the central computer transmits to the third computer a transmission command to transmit the case study to the user computer.

18. The formation and expansion method as claimed in claim 2, wherein the other computer is identical to the user computer.

19. A computer program product for a central computer, for carrying out a formation and expansion method as claimed in claim 2.

20. A computer program product for a central computer, for carrying out a formation and expansion method as claimed in claim 4.

21. A computer program product for a central computer, for carrying out a formation and expansion method as claimed in claim 5.

22. The formation and expansion method as claimed in claim 11, wherein the computer is identical to the user computer, wherein the user computer transmits a selection criterion for case studies to the central computer, and wherein at least one of
the central computer transmits to the user computer at least one of case studies which satisfy the selection criterion and cross-references to case studies which satisfy the selection criterion, and
a further computer transmits to the user computer case studies which satisfy the selection criterion.

23. The formation and expansion method as claimed in claim 12, wherein the computer is identical to the user computer, wherein the user computer transmits a selection criterion for case studies to the central computer, and wherein at least one of
the central computer transmits to the user computer at least one of case studies which satisfy the selection criterion and cross-references to case studies which satisfy the selection criterion, and
a further computer transmits to the user computer case studies which satisfy the selection criterion.

24. The formation and expansion method as claimed in claim 22, wherein the user computer transmits an identification code to the central computer at least one of before and together with the transmission of the selection criterion.

25. The formation and expansion method as claimed in claim 23, wherein the user computer transmits an identification code to the central computer at least one of before and together with the transmission of the selection criterion.

26. A computer program product for a computer for carrying out a formation and expansion method as claimed in claim 11.

27. A computer program product for a computer for carrying out a formation and expansion method as claimed in claim 12.

28. A computer program product for a computer for carrying out a formation and expansion method as claimed in claim 13.

29. A computer program product for a computer for carrying out a formation and expansion method as claimed in claim 14.

30. A computer program product for a computer for carrying out a formation and expansion method as claimed in claim 22.

31. A computer program product for a computer for carrying out a formation and expansion method as claimed in claim 23.

32. A computer program product for a computer for carrying out a formation and expansion method as claimed in claim 24.

33. A computer program product for a computer for carrying out a formation and expansion method as claimed in claim 25.

34. A formation and expansion method for a medical case study collection including a plurality of medical case studies, comprising:
transmitting at least one case study to a central computer from another computer; and
determining classification features relating to the case study and a cross-reference to the case study using the central computer, wherein the case study is retrievable via a user computer.

35. The formation and expansion method as claimed in claim 34, wherein the other computer transmits an identification code to the central computer at least one of before and together with the transmission of the at least one case study, and wherein the central computer stores the classification features and the cross-reference in the case study collection upon the transmitted identification code corresponding to an authorization code which is contained in an access authorization list.

36. A computer program product for a central computer, for carrying out a formation and expansion method as claimed in claim 34.

37. A formation and expansion method for a medical case study collection including a plurality of medical case studies, comprising:
determining classification features relating to a case study and a cross-reference to the case study using a computer, wherein the case study is retrievable via a user computer; and
transmitting the classification features and the cross-reference from the computer to a central computer, wherein the classification features and the cross-reference are recorded by the central computer in a case study collection.

38. The formation and expansion method as claimed in claim 37, wherein the computer transmits an identification code to the central computer at least one of before and together with the transmission of the classification features and cross-reference, and wherein the central computer records the classification features and the cross-reference in the case study collection upon the transmitted identification code corresponding to an authorization code which is contained in an access authorization list.

39. A computer program product for a central computer, for carrying out a formation and expansion method as claimed in claim 37.
